(19) United States
(12) Patent Application Publication
(10) Pub. No.: US 2016/0270887 A1
(43) Pub. Date: Sep. 22, 2016

(54) BioRoot(R) anatomic endosseous dental implant

(71) Applicant: Thomas Stewart Pearson, Clovis, CA (US)

(72) Inventor: Thomas Stewart Pearson, Clovis, CA (US)

(21) Appl. No.: 14/545,036

(22) Filed: Mar. 19, 2015

(51) Int. Cl. A61C 8/00; A61C 8/02

(52) U.S. Cl. CPC A61C 8/0036; A61C 8/0043; A61C 8/0075; A61C 8/0006; A61C 2008/0046

(57) ABSTRACT

The BioRoot® anatomic endosseous dental implant begins as a block of yttria-stabilized, zirconia oxide (MOL3% Y3ZrO2) that is milled and processed into a single piece dental implant with a custom built abutment to which a dental prosthesis can be attached after a three to four month osseointegration period, with unique retention devices that can be round, ovoid, or oblong-shaped, of any size desired with a varied number of holes (See Drawings FIGS. 1, 1 and 2, FIGS. 2, 1 and 2, and FIGS. 3, 1 and 2) which through the osseointegration process will become anchors between the implant surface and the alveolar walls of the extracted tooth root socket that minimize bone resorption, increase bone-to-implant contact, increase initial implant stability and enhance overall osseointegration.

The present invention is referred to as BioRoot® anatomic endosseous dental implant.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING

None.

### BACKGROUND OF THE INVENTION

The invention described herein is in the field of dental implants, the history of which has brought innumerable designs and theories, composition and installation, but more precisely, this application describes how to manufacture and how to place an implant that follows natural human physiology and avoid unnecessary invasive dental procedures that result in direct and indirect failures, unnecessary suffering, lengthy healing periods, and financial expenditures.

Typically the dental implant process in today's market involves extensive invasive procedures because of mass marketing implant designs that force practitioners to remodel a patient's jaw due to the implants' shape. It is time for a paradigm shift in dental implantation and the instant implant addresses these concerns.

This application for a BioRoot® anatomic endosseous dental implant patent describes a new concept: Instead of designing a typically cylindrical-shaped implant to insert into a prepared osteotomy, why not design an implant that follows the extracted tooth and existing tooth root socket shape in the alveolar bone? It could be simply stated this way: Make the implant fit the tooth root socket instead of making the tooth root socket fit the implant. Once a tooth is extracted, the periodontal ligament is removed and the socket is curetted to prepare for the implant insertion within fourteen days post extraction. This time is necessary to procure measurements of the extracted tooth and tooth root socket needed to manufacture the BioRoot® anatomic endosseous dental implant and avoid the bone resorption and socket remodeling that occurs at three weeks post extraction.

Current screw-type implants available in the marketplace require a drill guide, up to five or six successively larger drill bit sizes are used to remove bone, and finally, a reaming bit is to make a collar for the implant before placing the implant. Some metallic implants require a metallic sleeve be inserted rotationally before the implant can be inserted into the sleeve (also inserted rotationally). All implants require approximately three to four months to osseointegrate before being placed into occlusion, with a crown attached, but some implants require more time to heal, more surgeries and more parts, especially when using metallic implants.

Important and distinct disadvantages, risks, and dangers are associated with the rotationally-inserted metallic implant process: damage to the maxilla/mandibular bones by the screw-in process (excess torque can fracture a jaw), an ever present risk of infection, incompatibility (metallic allergies of metal-to-human tissues), bodily rejection, and increased risk associated with invasive medical procedures. Some risks are: cutting a flap, sutures and removal of same, sinus penetrations, alveolar, facial and vocal paralysis from nerve involvement and/or interruption of the blood supply.

The BioRoot® anatomic endosseous dental implant as disclosed herein is designed and manufactured to counter the disadvantages noted above by approximating an existing, extracted tooth root structure and by being hand-implanted and tapped into place using a mallet and driver. This process avoids the invasive drilling and the possibility of metal allergies because the implant is manufactured from a ceramic product called yttria-stabilized, zirconia oxide (3% MOL Y3ZrO2). Additionally, the BioRoot® anatomic endosseous dental implant does not contain threaded parts so it is not screwed or rotationally inserted in a threaded fashion which requires a torqued insertion that places unnatural force application on the oral cavity structure, which increases the likelihood of mandibular/maxilla fractures. Also, this unique design of the instant device allows for excellent retention and initial implant stability, rapid osseointegration, less opportunity for implant rejection, and because each implant is individually custom made, this allows for user-defined additions or subtractions to be installed on the implant as desired by the attending dental practitioner.

Important considerations which bear measurably on the success or failure of today's implants are stress and shear forces from mastication and how they can be dissipated within the tooth root socket. U.S. Pat. No. 5,427,526, (Fernandes), 1995, discloses “ . . . cylindrical implants poorly distribute compressive forces and generate shear forces that may fragment and break the bone surrounding the implant during function.” Fernandes also discloses that “There are two main types of conventional implants, press fit & threaded. Both types are installed into a prepared recess made in the alveolar bone.” The exception is the instant invention which being closely made to the shape and size of the existing tooth root socket with unique retention devices that insure the best possible fit, negates root socket preparation (Invasive drilling into bone, inserting metal socket receptacles, or adding bone material to modify sockets to accept or fit unnaturally-shaped implants). Fernandes further discloses that “ . . . one of the common causes of traditional implants' failure is excessive loading on a small section of alveolar bone due to the inadequate distribution of loading forces,” He also states that “ . . . screw implants exert six times the force of normal teeth on the alveolar bone . . . . ” BioRoot® anatomic endosseous dental implants totally avoid this proclivity by its physical outline with retentive devices that will adhere to the alveolar socket bones, including mesial, distal, buccal, and lingual, providing a more stable environment for osseointegration.

Fernandes also mentions a conically-tapered implant in U.S. Pat. No. 3,979,828 (Taylor), “ . . . more favorable force distribution would be obtained if the implant taper closely matches the recess in the alveolar bone after a single rooted tooth has been extracted.” A major benefit of the instant invention is exactly that, it approximates the extracted tooth root and tooth root socket of the alveolar bone with its anatomic shape and retentive devices. U.S. Pat. No. 5,766,010, (Uemura), discloses that in JA Pat. Pub. No. 7-36827, “ . . . this implant body (cylindrical-shaped), has a problem because stress is concentrated at corners of the implant body, that the implant body itself has a tendency to be broken and parts of bone are likely to be damaged.” The instant implant with its unique macro retentions will be able to closely follow the extracted tooth root shape and bond itself to the socket walls firmly, avoiding the stresses leading to broken/damaged bones.

Fernandes states that in U.S. Pat. No. 3,979,828 (Taylor), 1976, “The press-fitted implant lacks a micro retention mechanism, making it vulnerable to movement.” With the anatomic endosseous dental implant, the novel design allows for user-defined additions and/or subtractions on the implant body and root surfaces. These unique retentive devices represent a departure from typical macro retentions in that they are raised areas (from 2 nm up to 2 mm in height), running from the implant surface to the top center of the device and back down to the implant surface; they can be strictly circular, oblong, or ovoid-shaped depending on the user's requirements and since their shape mimics the original tooth prior to extraction, there is a higher likelihood of physical acceptance in the alveolar bone. These retentive devices are designed to appear in all four tooth surfaces: mesial/distal and buccal/lingual, but they will be more pronounced in the mesial/distal areas where there is softer bone, and less pronounced in the buccal/lingual areas to avoid damage or injury to the brittle cortical bone. Additionally, these macro retentions have circular holes in them, made by the CAD-CAM equipment. These holes are used to in-fill with osteoblasts and other bone-forming cells during the osseointegration phase. As the holes fill in and surrounding areas have increasing bone-to-implant contact (BIC), they will act as anchors between the implant and alveolar bone, causing an earlier and more reliable implant position with minimal bone resorption and minimize stress within the socket, providing better initial implant stability

Another key feature addressed by Fernandes is seen in the Canadian Pat. App. No. 2,029,646, laid open to Propper in 1991, whereby he discusses difficulties experienced in the process of obtaining implant forms from the extracted tooth root sockets using conventional means such as impression material which can seep into the surrounding tissue (especially sensitive sinus areas), where infection can occur and resulting facial/sinus surgery could result. Using detailed examination, modern x ray, cone beam scanning, and MRI technologies, accurate measurements can be obtained without dangers noted above.

Another feature of the BioRoot® anatomic endosseous dental implant is surface preparation. After milling the desired form with the micro retentions to specification while the implant is in its green (non-sintered) state, the relatively smooth implant goes through a blasting phase to roughen the surface for more efficient and effective osseointegration. This blasting phase utilizes Zirblast® Ceramic Beads (B30), from 425 to 600 nm in size, consisting of approximately 60 to 70% ZrO2, 28 to 33% SiO2, and <10% Al2O3, blasting at from 103 to 147 psi, for a short time ranging from 0.2 sec to 0.7 sec, leaving a roughened surface of from 80 to 100 nm. The implant is then sintered in an oven for approximately 8 hours at 130 degrees centigrade, slowly cooled and cleaned of surface impurities (if any) by water.

### BRIEF SUMMARY OF THE INVENTION

The instant implant is made to clearly satisfy the growing dental implant field with a truly anatomic tooth root implant that can be utilized quickly and simply, by hand insertion with a mallet and driver as needed, and with its unique macro retentive devices, offers initial stability and retention by the simultaneous BIC of all four tooth faces (mesial/distal, buccal/lingual), of the tooth root socket. By utilizing the instant invention, one can avoid all the invasive surgical procedures previously noted which will relieve a great deal of stress from both practitioner and patient, allowing more time to be spent focusing on the implant process instead of the pain, suffering, and adverse effects from any possible missteps during the implant procedure. The BioRoot® anatomic endosseous dental implant with its custom built abutment and retentive devices can be inserted within fourteen days of manufacture to avoid remodeling of the tooth root socket and bone resorption.

One additional advantage to the instant implant is a more even distribution of compressive forces and to minimize shear forces during function. By carefully manufacturing each implant to fit the existing tooth root structure of a recently extracted tooth, compressive forces are transferred along all four tooth root socket walls via the unique retentive devices, which will also reduce bone resorption, instead of focusing forces on the alveolar bone at the implant apex as occurs with rotationally inserted screw-type implants. U.S. Pat. No. 8,287,279 (Pirker), 2012, discloses retention devices of various shapes and sizes but the location of such devices are “strictly limited” to the interdental (mesial/distal), areas, leaving buccal/lingual sides non-utilized. At the opposite spectrum is U.S. Pat. No. 2,210,424 (Morrison), 1940, that discloses circular ring retentive devices that encircle the implant body without regard to any tooth face which (could these implants have been manufactured), would have resulted in root socket bone fracture or breakage, and excess bone resorption, ultimately ending in implant failure.

tooth face which (could these implants have been manufactured), would have resulted in root socket bone fracture or breakage, and excess bone resorption, ultimately ending in implant failure.

### BRIEF DESCRIPTION OF THE DRAWINGS

FIG. 1 shows a side view of a three-rooted tooth implant. The top portion has a custom built abutment (1) to which a crown or other prosthetic device can be attached; there are numerous rounded retentive devices (2) with various numbers of holes in them. The sizes of both the retentive devices and holes are representative only and can be made smaller or larger, of different shapes with a varied number of holes. Larger retentions have more holes, smaller retentions have less. Hole depth varies from 0.2 nm to 2 mm, but their purpose is constant: to fill in with bone-forming cells, becoming an “anchor,” between the implant and the alveolar bones they come in contact with during the osseointegation process.

FIG. 2 shows opposite sides view of a three-rooted tooth implant also with a custom built abutment on the implant top (1) to which a crown or other prosthetic device can be attached. Note how some retentive device positions (2) are mesial/distal, while others are buccal/lingual and some overlap both areas. All retentive devices have a varied number of holes to increase stability and osseointegration.

FIG. 3A shows a single-rooted dental implant side view with a custom built abutment (1) on the top portion to which a crown or other prosthetic device can be attached, and various positions of macro retention devices (2) on the lower implant body used to retain the implant and provide initial stability within the tooth root socket of a recently extracted tooth by allowing the implant to be wedged between the tooth socket's four walls.

FIG. 3B This image is the opposing side view of the single-rooted dental implant in FIG. 3A and also reveals a custom built abutment (1) on the top to which a crown or other dental prosthetic device can be attached. Various retentive devices (2) can also be seen as in FIG. 3A.

### DETAILED DESCRIPTION OF THE INVENTION

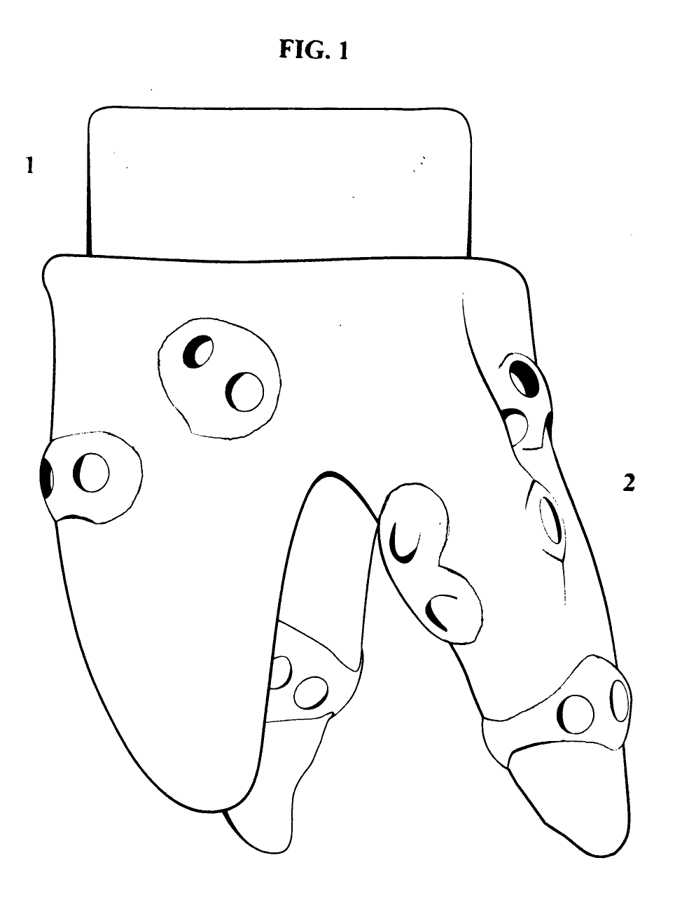

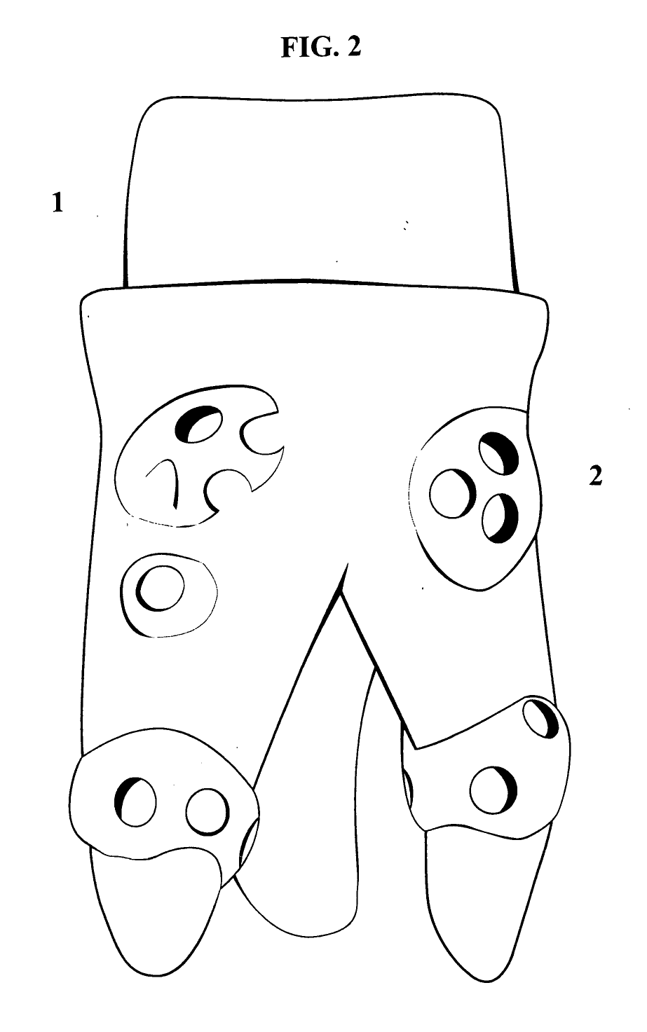

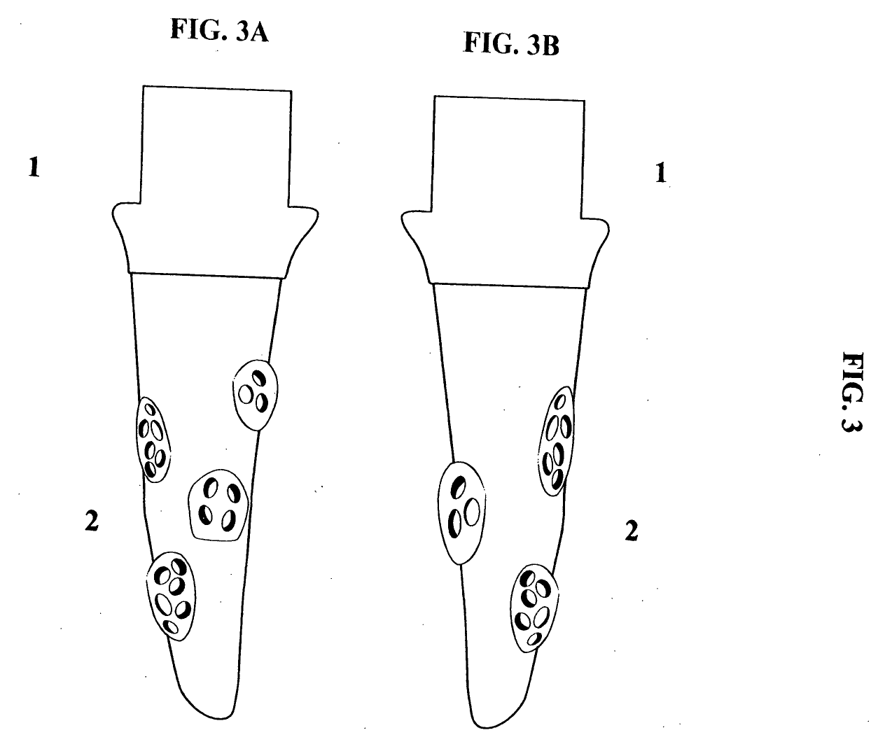

BioRoot® anatomic endosseous dental implant begins as a solid block of 3% MOL yttria-stabilized, zirconia oxide (Y3ZrO2), a biocompatible ceramic material while in the green state (non-sintered). Utilizing acquired imaging ranging from a visual exam, x ray, cone beam scan, or MRI, exacting tooth and tooth root socket measurements are made and the data is fed into a computer along with the actually-extracted tooth as a model, and by way of a 3D scanner, the operator will make manipulations to the virtual tooth by removing minor surface defects and adding retentive devices (See drawings FIG. 1, FIG. 2, FIG. 3A, and FIG. 3B). These retentions will be placed on all four tooth faces: mesial, distal, and buccal, lingual, ranging in height from 2 nm to 2 mm. When the data has been fully manipulated, it is fed into milling machines that will then mill the implant blank to produce the BioRoot® anatomic endosseous dental implant with a custom built abutment and a number of retentions with holes as desired by the user. The implant will then be sintered in an oven at approximately 1300 degrees centigrade for eight hours and slowly cooled. The final stage of implant processing is blasting which uses Zirblast® blasting beads (B30), from 425 to 600 nm in size, at 104 to 147 psi, for from 0.2 to 0.7 seconds at a distance of 0.1 to 3 mm, resulting in a surface roughness of from 70 to 100 nm. The instant device will be cleaned of surface impurities with water and sterilized in an autoclave and packaged in a sterile container for use.

What I claim as my invention is:

1-2. (canceled)

3. An anatomic endosseous dental implant called BioRoot®, made from 3% MOL yttria-stabilized zirconia oxide (Y3ZrO2), with unique retentive devices to fit an extracted tooth root socket.

4. A dental implant as claimed in 3 whereby the implant will be subjected to a surface roughening process while in its green (unsintered), state with specific parameters as follows: the implant surface will be air-blasted using Zirblast® blasting beads (B30), consisting of zirconium oxide, alumina oxide, silica, or a combination thereof, of from 425 to 600 um in size, at a pressure of from 3 to 10 atmospheres (710 kPa to 1014 kPa), (103 to 147 psi), for a short time of 0.2 to 0.7 seconds, and at a distance of from 0.2 to 5 mm which will result in a favorably roughened surface of from 20 to 200 urn; the implant will then be sintered in an oven at 1350 degrees centigrade for up to four hours and air-cooled for eight hours to achieve the desired hardness.

5. A dental implant as claimed in 3 whereby the unique retentive devices are not merely attached to the implant, but are CAD-CAM manufactured from the implant body's surface resulting in increased strength and rigidity during the osseointegrative process.

6. A dental implant as claimed in 4 wherein the retentive devices are gently-sloping surfaces rising to a crest and then sloping downward in all other directions, blending into the implant body surface.

7. A dental implant as claimed in 5 wherein the retentive devices form a mound shape which can be circular, oval, or undular, following the curved implant surface and can appear along the implant root, implant body, or may occupy both surfaces depending on the implant topography.

8. A dental implant as described in claim 6 whereby the retentive devices are further enhanced by machining them to have round holes placed along the mound surfaces with the hole depth varying with implant topography, generally from 2 um to 2 mm depending on user requirements.

9. A dental implant as described in claim 8 whereby as osseointegration occurs, osteoblasts and other bone-forming cells increase and adhere to the roughened implant surface eventually filling the holes made in the mounds, the entire retentive mound surface, the implant roots and the implant body as well, thereby increasing implant stability and rigidity, and magnifying the osseointegrative and adhesive effects.
